(19) United States
(12) Patent Application Publication
(10) Pub. No.: US 2023/0057020 A1
(43) Pub. Date: Feb. 23, 2023

(54) MEETING INTERACTION SYSTEM

(71) Applicant: FlatFrog Laboratories AB, Lund (SE)

(72) Inventor: Ola WASSVIK, Lammhult (SE)

(21) Appl. No.: 17/759,702

(22) PCT Filed: Feb. 9, 2021
(86) PCT No.: PCT/SE2021/050095

§ 371 Date: Jul. 28, 2022

(30) Foreign Application Priority Data
Feb. 9, 2020 (SE) 2030042-2

(51) Int. Cl. G06F 3/041; G06F 3/0482; G06F 3/01; G06F 3/0354; G06F 3/14; G06F 3/042

(52) U.S. Cl. CPC G06F 3/0416; G06F 3/0482; G06F 3/012; G06F 3/03545; G06F 3/14; G06F 3/0421; G06F 2203/04808; G06F 2203/04108; G06F 2203/04104

(57) ABSTRACT

Described is an interaction system comprising an imaging device, such as a camera system, configured to image one or more users, wherein the interaction device is configured to determine one of more properties of each user. For example, the interaction system may be used to determine whether the hand of each user is raised or an orientation of each user's face.

### TECHNICAL FIELD

The present disclosure relates to technologies for enhanced meeting room interaction experiences. In particular, the present disclosure relates to a meeting interaction system.

### BACKGROUND

Electronic interactive displays can be used in meetings to enhance interaction between a presenter and other participants in a meeting. Known interactive displays can allow a use to interact with a stylus or pen to better simulate writing on a whiteboard or flipchart.

Use of the electronic interactive displays can be non-intuitive if a user picks up a pen and does not know how the pen will interact with the interactive display. Further understanding of meeting participants behaviour during a meeting can be useful to the user of an interactive display.

### SUMMARY

Examples of the present disclosure aim to address the aforementioned problems.

According to an aspect of the present disclosure there is an interaction system comprising an imaging device configured to image one or more users, wherein the interaction device is configured to determine one of more properties of each user.

Optionally, the interaction system is configured to determine whether the hand of each user is raised.

Optionally, the interaction system is configured to determine an orientation of each user's face.

Optionally, the interaction system further comprises a display, and the interaction system is configured to determine an orientation of each user's face relative to the display.

Optionally, the interaction system further comprises a display and the interaction system is configured to determine an orientation of each user's face relative to one of the one or more users.

According to another aspect of the present disclosure there is an interaction system comprising an interactive display and a pen identification system configured to identify a pen used for interaction with the interactive display, wherein the interaction system is configured to display one or more properties of the pen on the interactive display whilst the pen is within a predetermined threshold distance of the interactive display but not in contact with the display.

Optionally, the properties of the pen comprises a pen colour.

Optionally, the properties of the pen comprises a pen brush type.

Optionally, the properties of the pen comprises a pen security property.

According to another aspect of the present disclosure there is an interaction system comprising an interactive display and configured to present a first menu interface to each of one or more users interacting with the interactive display, wherein the interaction system is configured to determine one or more properties of the one or more users and position the corresponding first menu interface on the interactive display accordingly.

Optionally, the first menu interface is positioned vertically in dependence on a user's height.

Optionally, a first menu interface is positioned horizontally in dependence on a user's horizontal position relative to the interactive display.

According to another aspect of the present disclosure there is an interaction system comprising an interactive display and processing unit configured to detect a hover event of an object remote from the interactive display for interaction with the interactive display and detect a touch event of the object with the interactive display wherein the interaction system is configured to display first information based on a determined object hover event and a display second information based on a determined object touch event.

Optionally, the interaction system is configured to display third information based on the determined object hover event and on the determined object touch event.

Optionally, the interaction system is configured to display the third information when the controller determines that the determined object hover event and the determined object touch event occur within a predetermined time period.

### BRIEF DESCRIPTION OF THE DRAWINGS

Various other aspects and further examples are also described in the following detailed description and in the attached claims with reference to the accompanying drawings, in which:

FIG. 1 shows a schematic view of view of a meeting room interaction system according to an example;

FIG. 2 shows a schematic view of view of a meeting room interaction system according to an example;

FIG. 3 shows a schematic view of view of a meeting room interaction system according to an example;

FIG. 4 shows a schematic side view of an optional touch-sensitive apparatus used with a meeting room interaction system according to an example;

FIG. 5 shows a schematic top view of a touch-sensitive apparatus used with a meeting room interaction system according to an example;

FIG. 6 shows a schematic view of a touch-sensitive apparatus connected to the meeting room interaction system according to an example; and

FIGS. 7, 8a, 8b, and 8c show examples of the meeting room interaction system whilst an object is hovering over or in contact with an interactive display.

### DETAILED DESCRIPTION

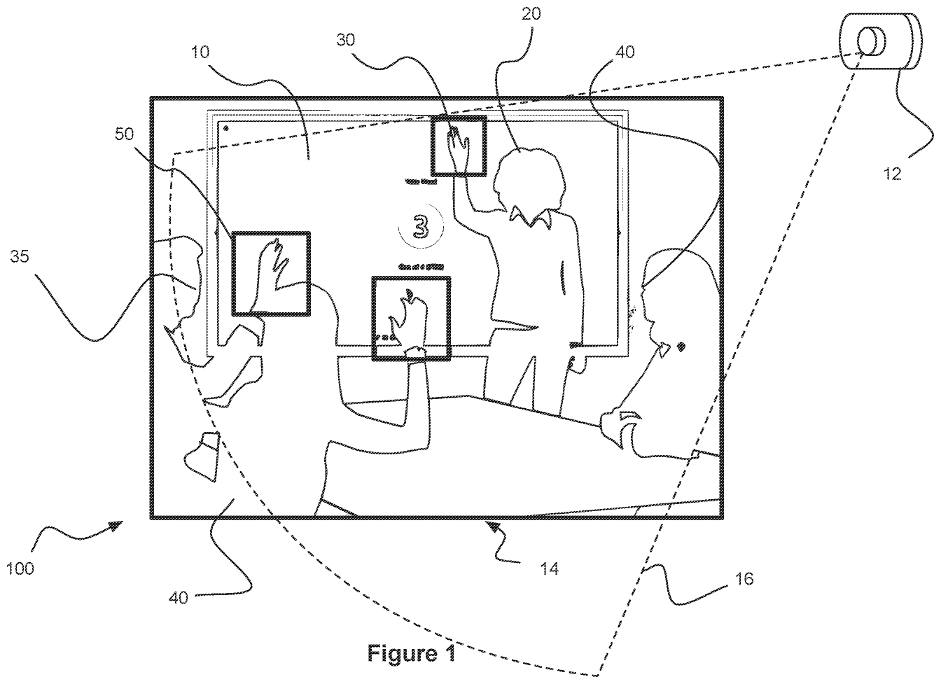

FIG. 1 shows an example of the description comprising a meeting room interaction system 100. The meeting room interaction system 100 comprises at least one imaging device 12 for imaging a set of users 20 in a space 14. The space 14 is in some examples a meeting room with one or more meeting participants 40 or users 20.

In some examples, a space 14 can comprise users 20 and meeting participants 40. In some examples, users 20 are interacting with the display 10, either using the display 10 to present information or using a touch enabled version of the display 10 to interact with the display 10. In some further examples, meeting participants 40 are people in the space 14 not using the display 10 directly. In some examples all the people in the space 14 can be users 20. In some other examples all the people in the space 14 can be meeting participants 40 for example if the meeting participants 40 are viewing the meeting presentation remote from a meeting presenter. There can be any number of meeting participants 40 or users 20 in the space 14. In this way, the meeting room interaction system 100 is an interaction system for either the users 20 and/or the meeting participants 40 during a meeting.

As mentioned above, the space 14 can be a meeting room. However in other examples, the space 14 can be any suitable space such as an auditorium, a boardroom, break-out room, collaborative space, an outside space, or any other suitable room or space for conducting a meeting.

In FIG. 1 there are shown a plurality of meeting participants 40 in the space 14. Indeed, there are three meeting participants 40 as shown in FIG. 1. In addition there is one user 20 using the display 10 to present to the meeting participants 40. However there can be any number of meeting participants 40 or users 20 as limited by the physical constraints of the space 14.

The imaging device 12 may comprise a visible light camera, an IR camera, a thermal camera, or any other type of camera suitable for imaging people. The imaging device 12 may comprise a depth camera, such as a time-of-flight camera or structured light camera, or other depth sensing apparatus such as LIDAR sensors. The imaging device 12 may comprise a combination of the imaging sensors described above or any other suitable sensor. The imaging device 12 may be positioned anywhere in the space 14, including mounted on a table, on the ceiling, or on a wall. The imaging device 12 may also be integrated into a display 10 present in the space 14.

FIG. 1 shows an exemplary position of the imaging device 12 mounted to a wall to the side of the display 10. As shown in FIG. 1, the imaging device 12 may have a field of view 16 which extends through the space 14. The imaging device 12 is configured to have a field of view 16 which encompasses all the meeting participants 40 or users 20 within the space 14.

In some examples, the imaging device 12 may be a stereo pair of imaging devices 12. Providing a pair of imaging devices 12 can increase the accuracy of determining the position of the meeting participants 40, user 20 or other objects with respect to the display 10.

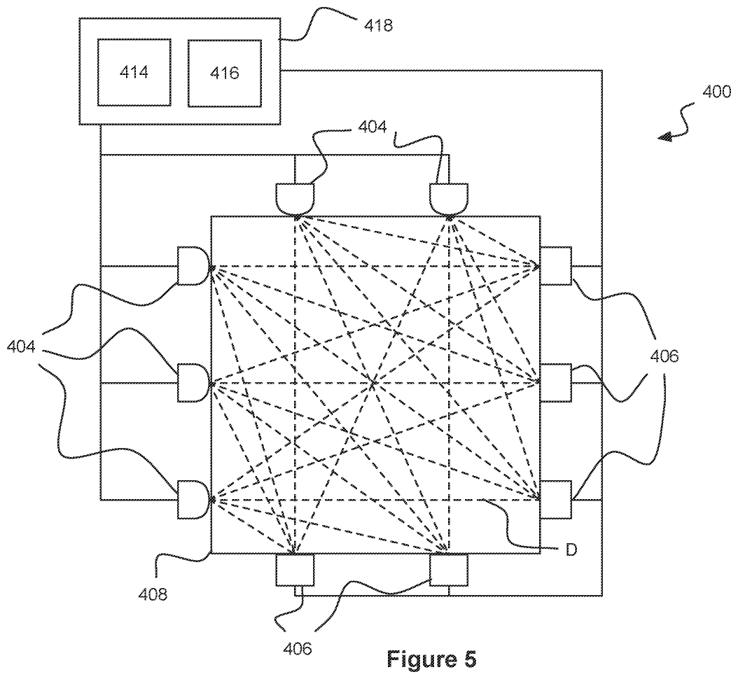

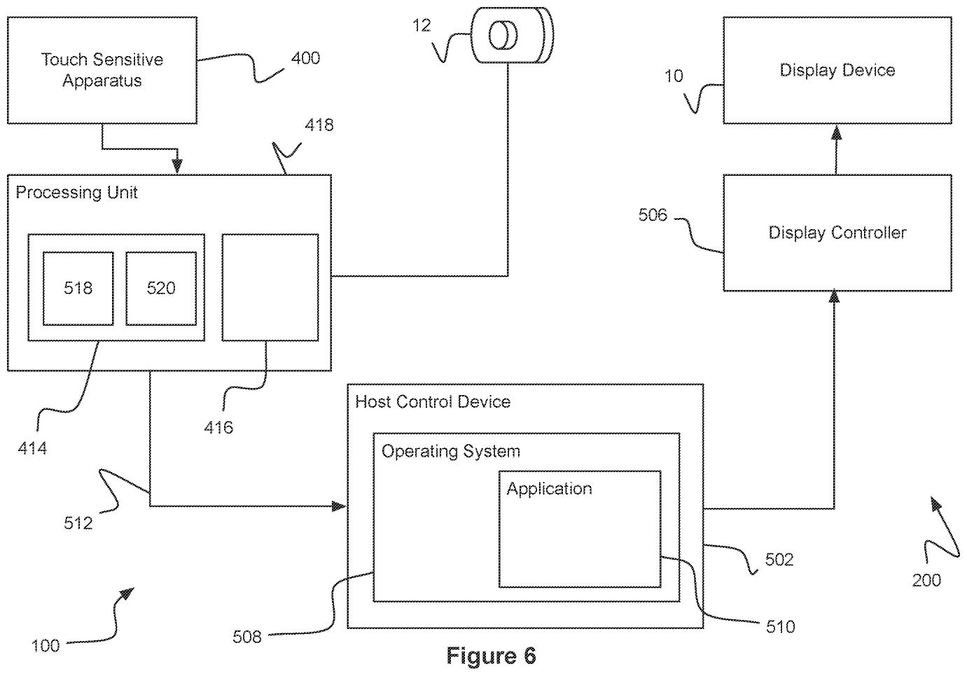

In some examples, the imaging device 12 is connected to the processing unit 418 (best shown in FIGS. 5 and 6). The processing unit 418 is configured to receive one or more signals from the imaging device 12 and determine one or more properties of the meeting participants 40, users 20, space 14 or any other meeting parameter.

In some examples the display 10 as shown in FIG. 1 is an LCD display, monitor, screen, or other suitable apparatus for displaying information to the meeting participants 40. In some examples the display 10 is optionally connected to a touch-sensitive apparatus 400 configured to provide touch interaction with a user 20.

Optionally, the meeting room interaction system 100 will be connected to a touch sensitive apparatus 400. However, in other examples, there is no touch-sensitive apparatus 400, and the meeting room interaction system 100 is configured to use other meeting participant information and input e.g., from the imaging device 12.

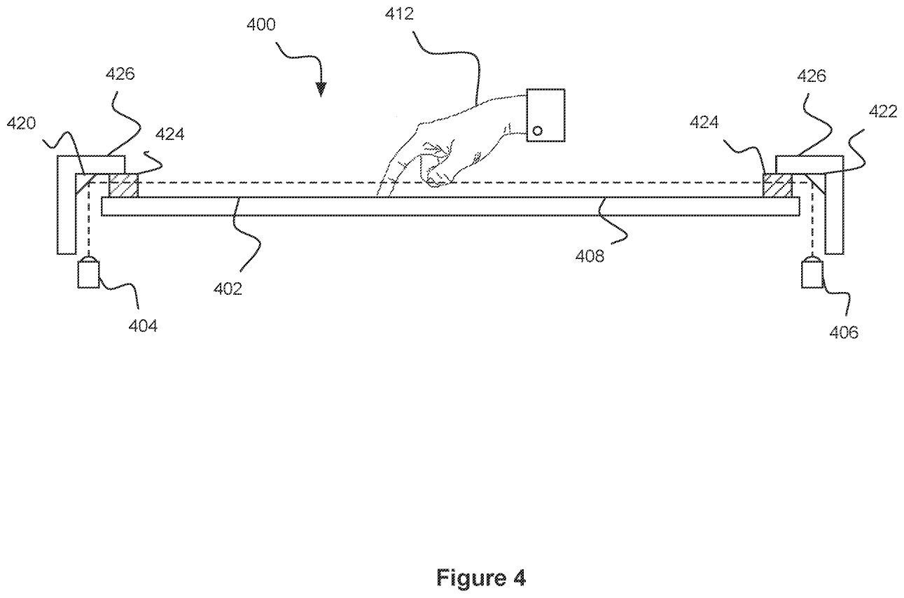

Reference will now be made to FIGS. 4, 5 and 6 to describe the meeting room interaction system 100 in more detail. FIGS. 4, 5, and 6 illustrate an optional example of a touch-sensitive apparatus 400 known as ‘above surface optical touch systems’. FIG. 4 shows a schematic side view of an optional touch-sensitive apparatus 400. FIG. 5 shows a schematic top view of a touch-sensitive apparatus 400. The touch-sensitive apparatus 400 comprises a set of optical emitters 404 which are arranged around the periphery of a touch surface 408. FIG. 6 shows a schematic view of a touch-sensitive apparatus 400 connected to the meeting room interaction system 100.

The emitters 404 are configured to emit light that is reflected to travel above a touch surface 408. A set of light detectors 406 are also arranged around the periphery of the touch surface 408 to receive light from the set of emitters 404 from above the touch surface 408. An object 412 that touches the touch surface 408 will attenuate the light on one or more propagation paths D of the light and cause a change in the light received by one or more of the detectors 406. The location (coordinates), shape or area of the object 412 may be determined by analysing the received light at the detectors.

In some examples, the emitters 404 are arranged on a substrate (not shown), and light from the emitters 404 travel above the touch surface 408 of a panel 402 mounted in a frame housing 426 via reflection or scattering on an edge reflector 420 or diffusor. The emitted light may propagate through a light transmissive sealing window 424. The light transmissive sealing window 424 allows light to propagate therethrough but prevents ingress of dirt into the frame housing 426 where the electronics and other components are mounted. The light will then continue until deflected by a corresponding edge reflector 422 at an opposing edge of the touch panel 402, where the light will be scattered back down around the touch panel 402 and onto the detectors 406. The touch panel 402 can be a light transmissive panel for allowing light from the display 10 propagating therethrough.

In this way, the touch sensitive apparatus 400 may be designed to be overlaid on or integrated into a display device or monitor. Alternatively, the touch panel 402 can be opaque and located remote from the display 10.

The touch sensitive apparatus 400 allows an object 412 that is brought into close vicinity of, or in contact with, the touch surface 408 to interact with the propagating light at the point of touch. In FIG. 1, the object 412 is a user's hand, but in other examples it is a pen, board eraser or any other object. In this interaction, part of the light may be scattered by the object 412, part of the light may be absorbed by the object 412, and part of the light may continue to propagate in its original direction over the panel 402.

The detectors 406 collectively provide an output signal, which is received and sampled by a signal processor 414. The output signal may contain a number of sub-signals, also denoted “projection signals”, each representing the energy of light emitted by a certain light emitter 404 and received by a certain light sensor detector 406. Depending on implementation, the signal processor 414 may need to process the output signal for separation of the individual projection signals. Conceptually, the touch sensitive apparatus 400 is considered to define a grid of detection lines D (as shown in FIG. 5) on the touch surface 408, where each detection line D corresponds to a light propagation path from an emitter 404 to a detector 406, as projected onto the touch surface 408. Thus, the projection signals represent the received energy or power of light on the individual detection lines D. It is realized that the touching object 412 results in a decrease (attenuation) of the received energy on one or more detection lines D.

The signal processor 414 may be configured to process the projection signals so as to determine a distribution of signal strength values (for simplicity, referred to as a “touch surface pattern”) across the touch surface 408, where each signal strength value represents a local attenuation of light. The touch surface pattern may be represented in many different ways, e.g. as signal strength values arranged in a regular x-y grid, such as in an ordinary digital image, although other types of grids are conceivable, e.g. hexagonal patterns or triangular meshes. The touch surface pattern is also known as “reconstruction” and in some examples, the reconstruction is carried out by a reconstruction module 518 as shown in FIG. 6. One reconstruction technique is tomographic reconstruction which is described in WO 2011/139213 and is incorporated herein by reference. Other reconstruction techniques for determining the touch surface pattern can be used.

The signal processor 414 is configured to carry out a plurality of different signal processing steps in order to extract touch data for at least one object. Additional signal processing steps may involve filtering, back projection, smoothing, and other post-processing techniques as described in WO 2011/139213, which is incorporated herein by reference. In some examples the filtering and smoothing of the reconstructed touch data is optionally carried out by a filtering module 520 as shown in FIG. 6. The reconstructed touch data is passed from the reconstruction module 518 to the filtering module 520 in order to remove noise and other possible errors in the reconstructed touch surface pattern.

Turning back to FIG. 5, in the illustrated example, the touch-sensitive apparatus 400 also includes a controller 416 which is connected to selectively control the activation of the emitters 404 and, possibly, the readout of data from the detectors 406. The signal processor 414 and the controller 416 may be configured as separate units, or they may be incorporated in a single unit. One or both of the signal processor 414 and the controller 416 may be at least partially implemented by software executed by a processing unit 418. In some examples the processing unit 418 can be a touch controller. The reconstruction and filtering modules 518, 520 of the signal processor 414 may be configured as separate units, or they may be incorporated in a single unit. One or both of the modules 518, 520 may be at least partially implemented by software executed by the signal processor 414 or the processing unit 418.

The processing unit 418 may be implemented by special-purpose software (or firmware) run on one or more general-purpose or special-purpose computing devices. In this context, it is to be understood that each “element” or “means” of such a computing device refers to a conceptual equivalent of a method step; there is not always a one-to-one correspondence between elements/means and particular pieces of hardware or software routines. One piece of hardware sometimes comprises different means/elements. For example, a processing unit 418 may serve as one element/means when executing one instruction but serve as another element/means when executing another instruction. In addition, one element/means may be implemented by one instruction in some cases, but by a plurality of instructions in some other cases. Naturally, it is conceivable that one or more elements (means) are implemented entirely by analogue hardware components.

The processing unit 418 may include one or more processing units, e.g. a CPU (“Central Processing Unit”), a DSP (“Digital Signal Processor”), an ASIC (“Application-Specific Integrated Circuit”), discrete analogue and/or digital components, or some other programmable logical device, such as an FPGA (“Field Programmable Gate Array”). The processing unit 418 may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software and associated control parameter values may be stored in the system memory, or on other removable/non-removable volatile/non-volatile computer storage media which is included in or accessible to the computing device, such as magnetic media, optical media, flash memory cards, digital tape, solid state RAM, solid state ROM, etc. The processing unit 418 may include one or more communication interfaces, such as a serial interface, a parallel interface, a USB interface, a wireless interface, a network adapter, etc, as well as one or more data acquisition devices, such as an ND converter. The special-purpose software may be provided to the processing unit 418 on any suitable computer-readable medium, including a record medium, and a read-only memory.

It is to be understood that FIGS. 4, 5, 6 merely illustrates one example of an above surface optical touch system and may not be used in some examples of the meeting room interaction system 100. However, it should be understood that the concepts discussed in the summary of the disclosure and claims and the examples can be applied to any other above surface optical touch system configuration as well as non-above surface optical touch system types which perform touch detection in frames. In some examples the touch-sensitive apparatus 400 can use one or more of the following including: frustrated total internal reflection (FTIR), resistive, surface acoustic wave, capacitive, surface capacitance, projected capacitance, above surface optical touch, dispersive signal technology and acoustic pulse recognition type touch systems. The touch-sensitive apparatus 400 can be any suitable apparatus for detecting touch input from a human interface device.

The relationship between the touch-sensitive apparatus 400 and an interactive display 200 will now be discussed in reference to FIG. 6. FIG. 6 shows a schematic representation of an interactive display 200 having a touch system. The interactive display 200 comprises the touch-sensitive apparatus 400, a host control device 502 and a display 10. The display 10 is configured to display the output from the host device 502. The display 10 can be any suitable device for visual output for a user such as a monitor. The display 10 is controlled by a display controller 506. Display 10 and display controllers 506 are known and will not be discussed in any further depth for the purposes of expediency. In some examples the display controller 506 is a “T-Con” although other display controllers can be used.

The host control device 502 is connectively coupled to the touch-sensitive apparatus 400. The host control device 502 receives output from the touch-sensitive apparatus 400. In some examples the host control device 502 and the touch-sensitive apparatus 400 are connectively coupled via USB connection 512. In other examples other wired or wireless data connection 512 can be provided to permit data transfer between the host control device 502 and the touch-sensitive apparatus 400. For example, the data connection 512 can be ethernet, firewire, Bluetooth, Wi-Fi, universal asynchronous receiver-transmitter (UART), or any other suitable data connection. In some examples there can be a plurality of data connections between the host control device 502 and the touch-sensitive apparatus 400 for transmitting different types of data. The touch-sensitive apparatus 400 detects a touch object when a physical object is brought in sufficient proximity to, a touch surface 408 so as to be detected by one or more detectors 406 in the touch-sensitive apparatus 400. The physical object may be animate or inanimate. In preferred examples the data connection 512 is a human interface device (HID) USB channel. The data connection 512 can be a logical or physical connection.

In some examples the touch-sensitive apparatus 400, the host control device 502 and the display 10 are integrated into the same device such as a laptop, tablet, smart phone, monitor or screen. In other examples, the touch-sensitive apparatus 400, the host control device 502 and the display 10 are separate components. For example, the touch-sensitive apparatus 400 can be a separate component mountable on a display screen.

The host control device 502 may comprise an operating system 508 and one or more applications 510 that are operable on the operating system 508. The one or more applications 510 are configured to allow the user to interact with the touch-sensitive apparatus 400 and the display 10. The operating system 508 is configured to run the one or more applications 510 and send output information to the display controller 506 for displaying on the display 10. The applications 510 can be drawing applications or whiteboards applications for visualising user input. In other examples the applications 510 can be any suitable application or software for receiving and displaying user input.

Turning back to FIG. 1, examples of the meeting room interaction system 100 will now be discussed. The display 10 as shown in FIG. 1 can be either a touch interactive display or a non-touch interactive display.

In one example, the imaging device 12 is configured to image the users 20 in the space 14 and the processing unit 418 is configured to determine whether a user's hand 30 is raised or not from the captured image. This may be determined heuristically or via a trained machine learning system. Examples of heuristic determination of a raised user hand 30 may include determining the position of a first and second highest body part. If the smallest body part of the first and second body part is raised above a certain threshold relative to the larger body part, a determination is made that the user's hand 30 is raised. A determination of raised user hands 30 can be used, for example, to determine engagement of a meeting or to count votes from users in votes. Alternatively or additionally, a determination by the processing unit 418 is made based on, contrast, colour, or motion of the hand 30 to determine the position of the hand 30. Alternatively or additionally, a determination by the processing unit 418 is made based on the distance and/or velocity a body part moves, for example a hand 30 moves from a position on the table to a position above a head. Accordingly, based on the speed and trajectory of the hand 30, a determination by the processing unit 418 is made that a user 20 has raised their hand 30. Additionally, or alternatively, the user 20 may hold an object such as a baton which is trackable by the processing unit 418. Tracked movement of the baton or other object can reveal the intention of the user 20 e.g. a raised hand 30.

In one example, the imaging device 12 is configured to image the users 20 in the space 14 and the processing unit 418 is configured to determine whether a user's face 35 is orientated towards a specific location in the space 14 e.g. the meeting room from the captured image. In one example, the location is the location of a specific user 20, or the location of the display 10. The orientation of a user's face 35 may be determined heuristically or via a trained machine learning system. Examples of heuristic determination of the orientation of the user's face 35 may include determining the position of the user's facial features, such as eyes and mouth and extrapolating and determining a facial direction vector in dependence on said features.

In one example of the description, a display 10 is present in the room and the people present in the room is divided into users 20 and meeting participants 40. In this example, users 20 are interacting with the display 10, either using the display 10 to present information or using a touch enabled version of the display 10 to interact with the display 10. Meeting participants 40 are people in the room not using the display 10 directly. In one example, users 20 may be positioned close to the display 10 and may or may not be standing up. Meeting participants 40 may be further away from the display 10 and may or may not be sitting down. In one example, processing unit 418 of the meeting room interaction system 100 may be configured to determine facial orientation and or hand 30 raised status of users 20 independently of meeting participants 40. A determination of facial orientation can be used, for example, to determine engagement of users 20 in a meeting to the information that is being presented.

In one example, the imaging device 12 is configured to image the users 20 in the space 14 and the processing unit 418 is configured to determine a meeting status of a meeting participant 40 or user 20 based on posture, facial orientation and hand 30 raised status in the captured image. The meeting status of a meeting participant 40 or user 20 may be determined heuristically or via a trained machine learning system. Examples of heuristic determination of the orientation of the user's face 35 may include determining the position of the user's facial features, such as eyes and mouth and extrapolating and determining a facial direction vector in dependence on said features.

Further examples of heuristic determination may be determining the posture of the meeting participant 40 or user 20 based on the height and position of their head and hands 30 with respect to the display 10. Based on the meeting status, the meeting room interaction system 100 can determine whether a person in the space 14 is a meeting participant 40 or 20 is a presenter, a co-presenter, an audience member, or any other role having a special status or activity during a meeting.

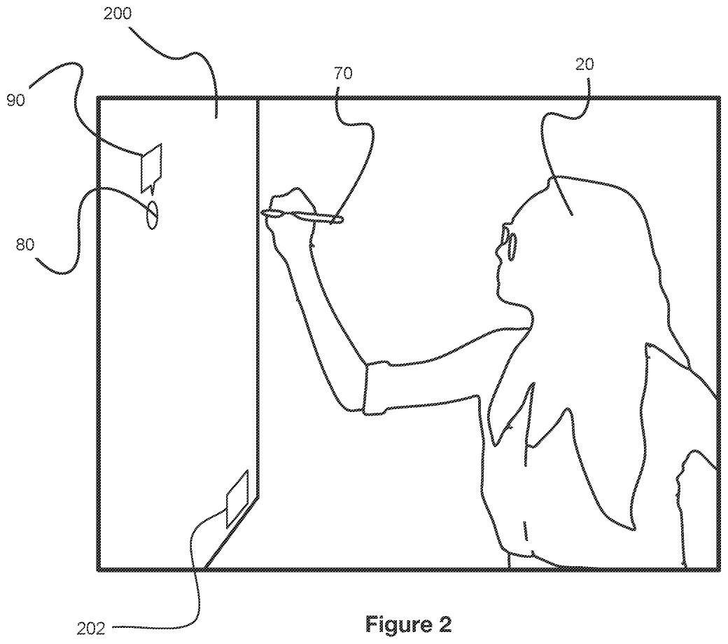

Turning to FIG. 2 another example will now be discussed. FIG. 2 shows an example of the disclosure comprising an interactive display 200. For example, the interactive display 200 comprises a display 10 and a touch-sensitive apparatus 400 as discussed in reference to FIGS. 4, 5, and 6 configured to receive touch interaction from a user 20.

The interactive display 200 may be optionally configured with a pen identification system for determining the identity of a pen 70. In some examples, the processing unit 418 is on configured to determine the identity of the pen 70. In other examples, the pen identification system is a separate processing unit from the processing unit 418. In one example, the pen 70 may be uniquely identified between a set of pens 70 (e.g. 4 pens—This may be achieved via optical identification of the pen) or may be more broadly uniquely identified. For example, the processing unit 418 is configured to distinguish different colours, patterns, or markings on each pen 70. In this way, the processing unit 418 is configured to use the differences in the optical appearances of the pens 70 to differentiate them. In some examples, the pens 70 in the space 14 may comprise a unique colour, pattern, shape or marking to identify the pen 70. In some examples, the different colours, patterns, shapes, or markings on each pen 70 are locally unique for example each different colours, patterns, shapes, or markings on each pen 70 associated with each pen 70 is different in the space 14. In other examples, the different colours, patterns, shapes, or markings on each pen 70 may be globally unique and no two pens 70 have the same optical appearance. E.g. Uniquely identified amongst all existing manufactured pens (this may be achieved, for example, via RFID based identification of the pen 70). In some examples, the processing unit 418 is configured to distinguish between the pens 70 with other identification methods such as optical QR codes, bar codes, etc. In other examples, only one type of pen is used and the step of identifying the pen 70 is not carried out.

In one example, the pen 70 may be optionally identified while in the user's hand 30 but before the pen 70 makes contact with the touch surface 408 of the interactive display 200. i.e. Whilst the pen 70 is ‘hovering’ near to the display 10. This step may be known as pen hover identification. In one example of the description, the interactive display 200 may be configured to display properties of the pen 70 on the display 10 after the pen 70 has been identified but while the pen 70 is still hovering. The processing unit 418 in combination with the imaging device 12 can determine the distance of the pen 70 from the interactive display 200 and therefore determine if the pen 70 is hovering e.g. causing a pen hover event. Furthermore, the processing unit 418 can determine when the last touch interaction associated with the pen 70 was made and therefore combine this with the determined distance information to determine a hover status of the pen 70.

In some examples, once the processing unit 418 has determined the pen hover identification, one or more types of information 90 that may be presented on the interactive display 200 whilst the pen 70 is still hovering. Alternatively, the step of pen hover identification is not necessary. Instead, information 90 is presented on the interactive display 200 after the processing unit 418 has detected a pen hover event.

As shown in FIG. 2, a message box 90 may pop up providing information to the user 20. In some examples, a hover pointer indicator 80 or “pen shadow” is displayed on the display 10 and the message box 90 is located adjacent to the hover pointer indicator 80. The hover pointer indicator 80 is the location of on the display 10 where the pen 70 would touch the display 10 if the user 20 moves the pen 70 towards the display 10. By locating the message box 90 adjacent to the hover pointer indicator 80, the user 20 understands that the information 90 contained in the message box 90 is associated with the particular pen 70 and/or user 20. The hover pointer indicator 80 and the message box 90 are optional. In some examples, no hover pointer indicator 80 and no message box 90 are displayed on the display 10. Instead the information 90 is presented at some visible location on the display 10. For example, the information 90 can be provided discreetly in a box 202 in a corner of the display 10 so that the image on the display 10 is not interfered with by the information 90.

In some examples the display 10 shows information 90 relating to the colour of the ink or other interaction colour that the pen 70 will apply to the interactive display 10 once contact is made between the pen 70 and the display 10. In one example, a colour indicator such a coloured dot or coloured shape is shown in the vicinity of the hovering pen.

In some examples the display 10 shows information 90 relating to the brush or other interaction shape that the pen 70 will apply to the interactive display 200 once contact is made between the pen 70 and the display 10. In one example, a shape indicator such as a brush shape or bush brush symbol type is shown in the vicinity of the hovering pen 70.

In some examples the display 10 shows information 90 relating to the user 20 associated with the identified pen 70. E.g. user identification and/or security requirements associated with the user (or pen). In one example, the user 20 is shown, in the vicinity of the hovering pen 70, a lock signal when the interactive display 200 determines that the identified pen 70 is not authorised to interact with the display 10 or that a password will be required first.

In some examples, the display 10 may provide an image with different layers and the pen 70 may interact with one or more layers. In some examples, once the processing unit 418 has determined the pen hover identification, layer information 90 of the image may be presented on the display 10 whilst the pen 70 is still hovering. Additionally or alternatively, one or more other types of information 90 with respect to the image displayed on the display 10 can be provided.

For example, information 90 comprising one or more of the filename, geographical location, physical office information, time or time zone information, language, pathname, layer number, slide number, slide title, software application information, software version number or any other information relating to the image, application, or system being used by the meeting room interaction system 100 can be provided on the display 10.

Whilst FIG. 2 shows a pen 70, the information 90 can also be provide when any other object hovers over the display 10. For example, the arrangement as described in reference to FIG. 2 can be applied to a finger, multiple figures, palm, brush, stylus, or any other object used for interaction with the interactive display 200.

The feature of displaying properties of the pen 70 on the interactive display 200 after the pen 70 has been identified but while the pen 70 is still hovering provides a significant advantage. Without this feature, a user needs to start applying the pen 70 to the touch surface 408 of the interactive display 200 to determine the type of interaction that is linked with a pen 70. E.g. Where a user 20 starts to work with a pen 70 and an interactive display 200, the user 20 may not know which colour the pen 70 is configured to output. The user 20 may be forced to draw a test line on the interactive display 200 to determine that the correct colour is set, before erasing the test line, picking the required colour, and beginning normal interaction with the device. The same applies to brush type and security settings associated with the pen 70. By displaying this information to the user 20 while the user 20 is preparing to interact with the interactive display 200 (e.g. when the pen 70 is hovering close to the interactive display 200), the user 20 can see in advance the interaction type associated with the pen 70. This can significantly improve user 20 satisfaction with the experience.

In one example of the description, the interactive display 200 may be configured to display a hover pointer indicator 80 while a finger, pen, or any other suitable touch interaction object is hovering closer to interactive display 200. The hover pointer indicator 80 may comprise a shape that becomes smaller in size as pen 70 is brought closer to the surface of interactive display 200, while becoming larger when pen 70 is moved away from the surface of interactive display 200. This provides the effect of providing an increasingly focussed hover pointer indicator 80 as the touch object is brought closer to the interactive display 200. In one example, the area of interactive display 200 surrounding the hover pointer indicator 80 may be darkened to provide a highlighting effect over the hover pointer indicator 80. In another example, the entire area of interactive display 200 outside of the shape of the hover pointer indicator 80 may be darkened. This can highlight a specific area of the interactive display 200. The darkening effect may then be removed as soon as the touch object makes contract with the touch surface 408 of interactive display 200. This may be particularly beneficial for indicating to a large number of meeting participants 40 in the meeting the specific part of the image which the user 20 is referring to. Providing a dynamic highlighting features associated with the pen 70 can be beneficial because meeting participants 40 will be able to clearly see the highlighted area the user is pointing to which may be harder with a mouse cursor or laser pointer.

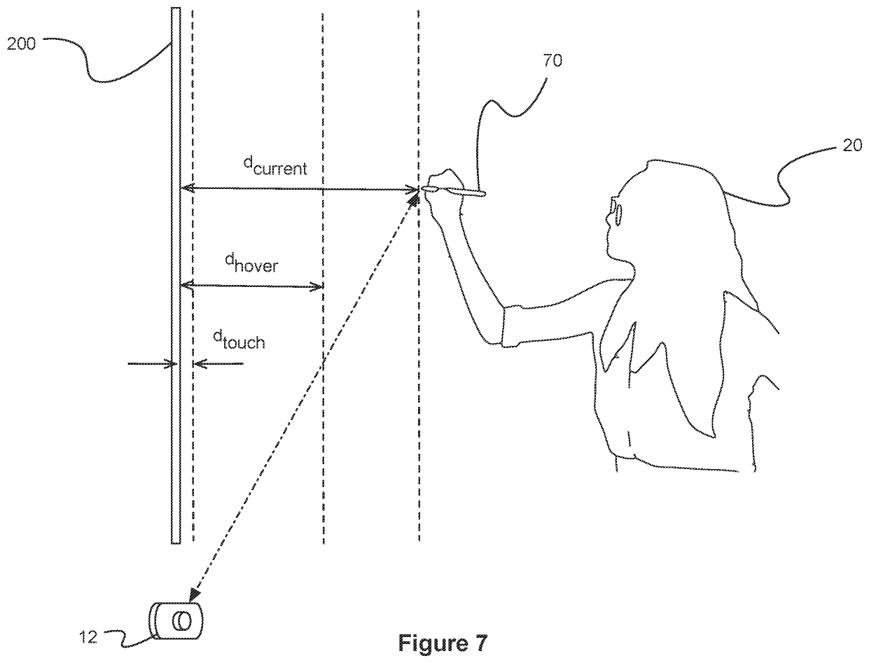

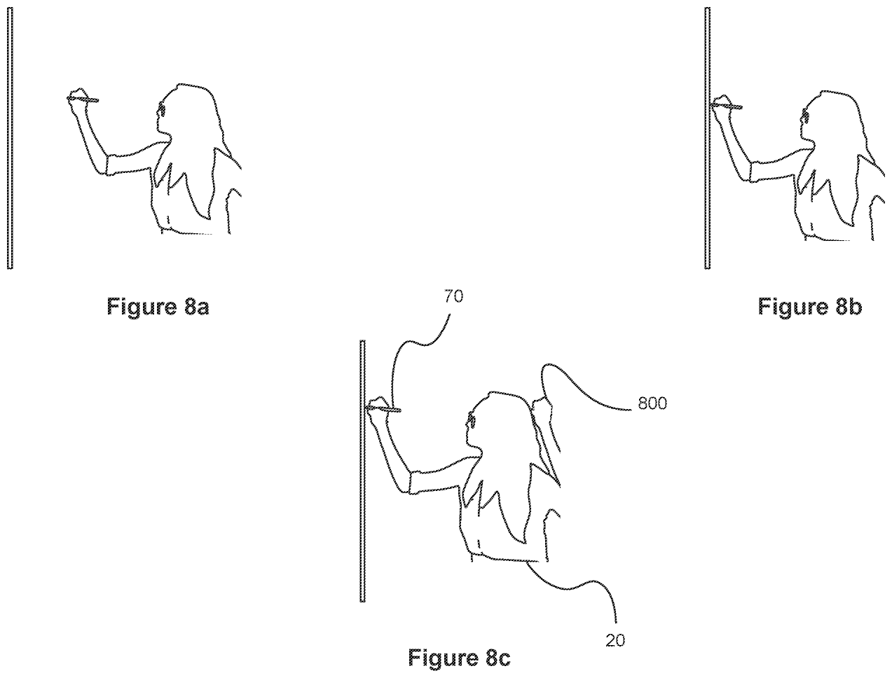

Reference to FIGS. 7, 8a, 8b, and 8c will now be made when discussing the meeting room interaction system 100 in more detail. FIGS. 7, 8a, 8b, and 8c show examples of the meeting room interaction system 100 whilst a pen 70 is hovering over or in contact with the interactive display 200. The term hovering means that the object e.g. the pen 70 interacting with the interactive display 200 is remote from the interactive display 200.

In some examples, the processing unit 418 determines that the pen 70 is remote from the interactive display 200 when the pen 70 is a distance from the interactive display 200 which is greater than a touch distance d_{touch}. When the pen 70 is at a distance from the interactive display 200 which is less than the touch distance d_{touch} the processing unit 418 detects a touch event with the touch-sensitive apparatus 400. In other words when the pen 70 is a distance from the interactive display 200 which is greater than a touch distance d_{touch}, no touch event is detected. Additionally or alternatively, the processing unit 418 determines that distance of the pen 70 from the interactive display 200 is less than the touch distance d_{touch} using the received images from the imaging device 12. An example of a touch event caused with the pen 70 is shown in FIG. 8b.

In some examples, the processing unit 418 determines that the pen 70 is hovering above the interactive display 200 when the pen 70 is at a distance from the interactive display 200 which is less than a predetermined hover distance dₕₒᵥₑᵣ and not causing a touch event to be detected with the touch-sensitive apparatus 400. The predetermined hover distance dₕₒᵥₑᵣ is a distance from the interactive display 200 whereby the processing unit 418 determines that the pen 70 is hovering over the interactive display 200 as discussed in reference to FIG. 2. The pen 70 as shown in FIG. 7 is positioned at a distance d_{current} which is greater than the predetermined hover distance dₕₒᵥₑᵣ. This means that the processing unit 418 does not detect that the pen 70 is hovering. When the position of the pen 70 d_{current} is less than dₕₒᵥₑᵣ, the processing unit 418 detects a pen hover event and one or more of the actions is initiated as discussed in reference to FIG. 2. An example of a pen hover event is shown in FIG. 8a. The processing unit 418 determines that current distance d_{current} of the pen 70 from the interactive display 200 using the received images from the imaging device 12.

In some examples the predetermined hover distance dₕₒᵥₑᵣ is 1 cm, 2 cm, 3 cm, 4 cm, 5 cm, 6 cm, 7 cm, 8 cm, 9 cm, 10 cm, 15 cm, 20 cm, 25 cm, 30 cm, 35 cm, 40 cm, 45 cm, 50 cm, 60 cm, 70 cm, 80 cm, 90 cm, 100 cm, 110 cm, 120 cm, 130 cm, 140 cm, 150 cm, 160 cm, 170 cm, 180 cm, 190 cm, or 200 cm.

In some examples the predetermined touch distance d_{touch} is 0 cm. In other words, the pen 70 or other object must touch the interactive display 200 to cause a touch event. In some other examples predetermined touch distance d_{touch} is 1 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, or 50 mm.

In some examples, the processing unit 418 is configured to detect a plurality of objects which interact with the interactive display 200. For example, the processing unit 418 determines the distance of a first interactive object from the interactive display 200 and the distance of a second interactive object from the interactive display 200. FIG. 8c shows a pen 70 touching the interactive display 200 and a hand 800 of the user 20 remote from the interactive display 200. The processing unit 418 determines that the pen 70 is positioned at a distance less than the touch distance d_{touch}. At the same time the processing unit 418 determines that the hand 800 is less than a predetermined hover distance dₕₒᵥₑᵣ. Based on the determination that there is a touch event and a hover event at the same time, the processing unit 418 is configured to modify the behaviour of interactive display 200 in response to the touch event.

For example, when the processing unit 418 determines that there is a simultaneous touch event and a hover event, the user 20 can perform a different action with the interactive display 200 other than writing. The different action can be one or more of functionality associated with a right button mouse click, a left button mouse click, a middle button mouse click, zoom in, zoom out, scroll, pan, rotate or any other user interaction. Similarly, the processing unit 418 can determine than both the pen 70 and the hand 800 are less than a predetermined hover distance dₕₒᵥₑᵣ, but not causing a touch event and modify the behaviour of interactive display 200 accordingly.

In some examples the processing unit 418 is configured to detect a hover event of an object e.g. the pen 70 remote from the interactive display 200 for interaction with the interactive display 200 and detect a touch event of the pen 70 with the interactive display 200. The processing unit 418 is configured to display first information based on a determined object hover event and a display second information based on a determined object touch event.

In some examples, the processing unit 418 is configured to display third information based on the determined object hover event and on the determined object touch event. In other words the interactive display 200 displays different information if both a touch event and a hover event are detected at the same time. In some examples, the processing unit 418 is configured to display the third information when the processing unit 418 determines that the determined object hover event and the determined object touch event occur within a predetermined time period. If the object hover event and the object touch event occur within a predetermined time period, they are determined by the processing unit 418 to occur at the same time otherwise the processing unit 418 determines that the object hover event and the object touch event are different user gestures.

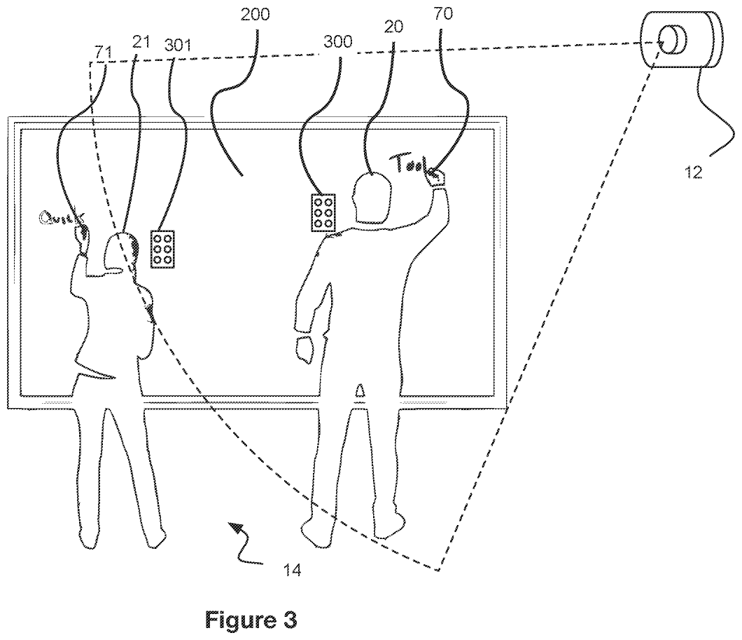

FIG. 3 shows an example of the description comprising a meeting room interaction system 100 comprising interactive display 200. Interactive display 200 comprises a display 10 and a touch surface 408 configured to receive touch interaction from a user 20.

The meeting room interaction system 100 comprises at least one imaging device 12 for imaging a set of users 20, 21 interacting with the interactive display 200. The imaging device 12 may comprise a visible light camera, an IR camera, a thermal camera, or any other type of camera suitable for imaging people. The imaging device 12 may comprise a depth camera, such as a time-of-flight camera or structured light camera, or other depth sensing apparatus such as LIDAR sensors. The imaging device 12 may comprise a combination of imaging sensors described above or as described with the examples discussed with reference to the other Figures. The imaging device 12 may be positioned anywhere in the space 14, including mounted on a table, on the ceiling, or on a wall. The imaging device 12 may also be integrated into the interactive display 200 present in the space 14.

In one example, one or more users 20, 21 are interacting with interactive display 200 using a first menu interface 300 shown on interactive display 200. The first menu interface 300 is positioned such that it is within easy reach of the user 20. The imaging device 12 is configured to image the users 20, 21 interacting with interactive display 200 and the meeting room interaction system 100 is configured to determine at least one of the following user properties: The height of a user 20, 21, and the horizontal position of the user 20, 21 relative to the interactive display 200.

In one example, the meeting room interaction system 100 is configured to change the position of the first menu interface 300 to a position convenient to the user 20, 21 and in dependence on the user's height and horizontal position. E.g. Where the user 20, 21 is shorter and standing towards the left of the interactive display 200 (as shown in FIG. 3), first menu interface 300 is positioned lower down on the interactive display 200 and on the left side of the display 10.

In one example where multiple users are interacting with the display 10, the meeting room interaction system 100 is configured to determine properties of each of the users. In one example, a height and horizontal position is determined for user 20 and first menu interface 300 is positioned accordingly (lower down and to the left), whilst a height and horizontal position is determined for a second user 21 and second menu interface 301 is positioned accordingly (higher up and to the right).

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. An interaction system comprising an imaging device configured to image one or more users, wherein the interaction device is configured to determine one of more properties of each user.

2. The interaction system of claim 1, wherein the interaction system is configured to determine whether the hand of each user is raised.

3. The interaction system of claim 1, wherein the interaction system is configured to determine an orientation of each user's face.

4. The interaction system of claim 3, wherein the interaction system further comprises a display, and the interaction system is configured to determine an orientation of each user's face relative to the display.

5. The interaction system of claim 3, wherein the interaction system further comprises a display and the interaction system is configured to determine an orientation of each user's face relative to one of the one or more users.

6. An interaction system comprising an interactive display and a pen identification system configured to identify a pen used for interaction with the interactive display, wherein the interaction system is configured to display one or more properties of the pen on the interactive display whilst the pen is within a predetermined threshold distance of the interactive display but not in contact with the display.

7. The interaction system of claim 6, wherein the properties of the pen comprises a pen colour.

8. The interaction system of claim 6, wherein the properties of the pen comprises a pen brush type.

9. The interaction system of claim 6, wherein the properties of the pen comprises a pen security property.

10. An interaction system comprising an interactive display (10) and configured to present a first menu interface to each of one or more users interacting with the interactive display, wherein the interaction system is configured to determine one or more properties of the one or more users (20) and position the corresponding first menu interface on the interactive display accordingly.

11. The interaction system of claim 10, wherein the first menu interface is positioned vertically in dependence on a user's height.

12. The interaction system of claim 10, wherein a first menu interface is positioned horizontally in dependence on a user's horizontal position relative to the interactive display.

13. An interaction system comprising an interactive display and processing unit configured to detect a hover event of an object remote from the interactive display for interaction with the interactive display and detect a touch event of the object with the interactive display wherein the interaction system is configured to display first information based on a determined object hover event and a display second information based on a determined object touch event.

14. An interaction system according to claim 13 wherein the interaction system is configured to display third information based on the determined object hover event and on the determined object touch event.

15. An interaction system according to claim 14 wherein the interaction system is configured to display the third information when the controller determines that the determined object hover event and the determined object touch event occur within a predetermined time period.
